(19) United States
(12) Patent Application Publication
(10) Pub. No.: US 2004/0098297 A1
(43) Pub. Date: May 20, 2004

(54) System for managing requests and method of managing requests

(76) Inventor: Alvin J. Borthwick, Victoria Park (AU)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/608,711

(22) Filed: Jun. 27, 2003

(30) Foreign Application Priority Data
Jun. 27, 2002 (AU) PS3248

(51) Int. Cl. G06F 17/60

(52) U.S. Cl. 705/10

(57) ABSTRACT

A system for managing requests comprising at least one communications line adapted to be used by a requestor to place a request with the system; request means for identifying contact details of the requestor and a stock item to which the request relates; and a user interface 10 having at least one indicator means 30 thereon, one of the indicator means associated with the stock item to which the request relates, where when a requestor places a request with the system, the indicator means 30 associated with the stock item to which the request relates is set to a first state indicating that at least one request associated with the stock item has not been attended to, and when all requests associated with the stock item have been attended to, the indicator means 30 associated with the stock item to which the request relates is set to a second state. Each stock item is assigned a stock code 32 and each indicator means 30 associated with a stock code 32 to allow stock items to be appropriately referenced.

### FIELD OF THE INVENTION

The present invention relates to a system for managing requests and a method of managing requests. The invention is particularly, though not exclusively, useful in advertising and marketing operations.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background of the invention is intended to facilitate an understanding of the present invention. However, it should be appreciated that the discussion is not an acknowledgement or admission that any of the material referred to was published, known or part of the common general knowledge of the person skilled in the art in any jurisdiction as at the date of the application.

With the development of the so-called “information age”, people have become inundated with requests for information. When such people are not in a position to immediately respond to such requests, systems need to be put in place to allow them to track the requests and deal with them at a more appropriate time.

In some instances, a calendar or text-based reminder system is used to fulfil this requirement.

The problem with such systems, however, is that the emphasis is placed on the person who receives the request for information to record an entry in the calendar or text-based reminder system.

A professional call monitoring and reporting service has also been developed and is described in U.S. Pat. No. 6,097,792 (“Thornton”). The invention the subject of the Thornton patent relates to a system whereby requests for information about a good or service are handled by an external party and details of requests made by customers passed on to the supplier of the good or service. However, there are three problems with the Thornton system, namely:

1. there is an on-going need for cross-communication between external party and supplier;

2. the third party, as the contact point for customers, has access to customer information that suppliers would, in other circumstances, like to keep solely to themselves; and

3. there is no provision for follow-up of the request for information, the external party of the Thornton system merely providing details of the customer making the request to the supplier.

Accordingly, it is an object of the present invention to provide a system for managing requests that automatically records a request for information in respect of a stock item and provides a visual indicator as to the status of requests in respect of a stock item to the person who is required to respond thereto. It is a further, optional, object of the present invention that the system be implemented in-house.

### DISCLOSURE OF THE INVENTION

In accordance with a first aspect of the invention, there is provided a system for managing requests comprising:

at least one communications line adapted to be used by a requester to place a request with the system;

request means for identifying contact details of the requestor and a stock item to which the request relates; and

a user interface having at least one indicator means thereon, one of the indicator means associated with the stock item to which the request relates,

where when a requester places a request with the system, the indicator means associated with the stock item to which the request relates is set to a first state indicating that at least one request associated with the stock item has not been attended to, and when all requests associated with the stock item have been attended to, the indicator means associated with the stock item to which the request relates is set to a second state.

Preferably, each stock item is assigned a stock code and each indicator means is associated with a stock code such that the association between indicator means and stock item is through the stock code. This allows for ease of reference within the log file.

Preferably, the request is placed in one of the following manners: telephone call; facsimile message; e-mail; short messaging system message.

Preferably, the request means identifies the contact details of the requestor by automatic caller identification. Although, other forms of automatic call identification can be implemented.

Preferably, the request means identifies the stock item to which the request relates by identifying the stock code contained within the request. In one instance, this can be achieved by capturing the digits pressed by the requestor after pressing a separator key.

Preferably, the request means also records details from the requestor as to the requestor's desired means of receiving information.

Preferably, the requestor receives a greeting message when the at least one communications line is used to place a request with the system.

Preferably, the indicator means is a graphical illustration of a light. When the indicator means is in a first state, the indicator means is periodically illuminated and, when the indicator means is in a second state, the indicator means is permanently illuminated.

Preferably, each indicator means displayed on the user interface has its associated stock code displayed substantially adjacent thereto. Each stock code has a colour state to indicate the state or actions that need to be performed in respect of the stock code.

Where a stock code is set to a first colour state to indicate that the stock code has not yet been associated with a stock item and is set to a second colour state to indicate that the stock code has been associated with a stock item. Furthermore, where a stock code is set to a third colour state to indicate that a sign or other form of notification or advertisement in respect of the associated stock item should be put up or placed and is set to a fourth colour state to indicate that a sign or other form of notification or advertisement in respect of the associated stock item should be taken down or discontinued.

Preferably, the user interface further includes a status box, the status box displaying the total number of stock codes set to each colour state.

Preferably, the user interface includes a counter window, the counter window displaying the total number of requests made in respect of a stock item on activation of the indicator means associated with the stock item.

Preferably, the system further comprising reminders means. The reminder means may be adapted to provide reminders to indicate that a sign or other form of notification or advertisement should be put up or placed and adapted to provide reminders to indicate that a sign or other form of notification or advertisement should be taken down or discontinued, each such reminder associated with a stock code.

Preferably, satisfying a reminder indicating that a sign or other form of notification or advertisement should be put up or placed changes the stock code to the third colour state and satisfying a reminder indicating that a sign or other form of notification or advertisement should be taken down or discontinued changes the stock code to the fourth colour state. If the reminder is not actioned within a predetermined time period, the stock code associated with the reminder flashes periodically.

Preferably, upon activation, the reminder is displayed in a scrolling text bar.

The system, in optional embodiments, further comprises inventory means for tracking the inventory of signs or other forms of advertisement.

Preferably, the user interface further comprises means for displaying contact details of the requestor and the stock code of the stock item to which the request relates.

Preferably, the stock codes are categorised and the user interface displays only those indicator means associated with a stock code of a single category.

The system optionally incorporates statistics means for generating statistical information in respect of requests, stock items and/or requesters.

Preferably, when the request means cannot identify the contact details of the requestor or the stock item to which the request relates, the request means presents to the requestor a menu, the menu allowing the requestor to enter in their contact details and/or designate the stock item to which the request relates.

Preferably, the system also includes at least one voice mailbox, each voice mailbox associated with a stock item, such that, when the means of placing the request is a telephone call, the requestor hears the message recorded in the voice mailbox associated with the stock item their request relates to. The system further provides means for recording a message and storing it in a voice mailbox. This means may allow for text to be converted into speech.

Preferably, the system further comprises suggestion means, the suggestion means adapted to search for stock items having similar characteristics to the stock item to which the requestor's request relates and providing details of the suggested stock items to the requestor.

Preferably, the system also comprises a screen display, the screen display being adapted to display real-time information in respect of requests. The screen display can be interactive in which case the user interface is adapted to accept a request from a requestor using the screen display.

In accordance with a second aspect of the invention, there is a user interface for a system for managing a request from at least one communication line, the request identifying a stock item to which the request relates, the user interface comprising at least one indicator means, one of the at least one indicator means associated with the stock item the request relates to, where, when a requestor places the request, the indicator means associated with the stock item is set to a first state indicating that at least one request associated with the stock item has not been attended to, and when all requests associated with the stock item have been attended to, the indicator means associated with the stock item to which the request relates is set to a second state.

Preferably, each stock item is assigned a stock code and the stock code is displayed on the user interface at a position substantially adjacent to the indicator means associated with the stock item, such that a visual association is formed between the indicator means and the stock code.

Preferably, the indicator means is a graphical illustration of a light. When the indicator means is in a first state, the indicator means is periodically illuminated and, when the indicator means is in a second state, the indicator means is permanently illuminated.

Preferably, each stock code has a state to indicate the status or actions that need to be performed in respect of the stock code. A stock code is set to a first state to indicate that the stock code has not yet been associated with a stock item and is set to a second state to indicate that the stock code has been associated with a stock item. Furthermore, a stock code is set to a third state to indicate that a sign or other form of notification or advertisement in respect of the associated stock item should be put up or placed and is set to a fourth state to indicate that a sign or other form of notification or advertisement in respect of the associated stock item should be taken down or discontinued.

Preferably, the user interface further comprises a counter window, the counter window displaying the total number of requests made in respect of a stock item on activation of the indicator means associated with the stock item.

In accordance with a third aspect of the invention there is provided a method of managing requests comprising:

receiving a request via a communications line;

identifying the contact details of the requestor and a stock item to which the request relates;

setting an indicator means associated with the stock item to a first state indicating that at least one request associated with the stock item has not been attended to; and

setting an indicator means associated with the stock item to a second state indicating when all requests associated with the stock item have been attended to.

Preferably, the method further comprises the steps of associating each stock item with a stock code and associating each indicator means with a stock code.

Preferably, the step of identifying the stock item to which the request relates comprises the steps of identifying the stock code contained within the request and identifying the stock item associated with the stock code contained within the request.

Preferably, the method further comprises the step of obtaining details of the requestor's desired means of receiving information. It is also of advantage if the method includes the step of sending a greeting message upon receipt of a request.

Preferably, the method further comprises the steps of:

displaying the stock code substantially adjacent to the indicator means so that a visual association is formed there between;

setting stock codes not associated with a stock item to a first colour state;

setting stock codes associated with a stock item to a second colour state;

Additionally, the method may further comprise the steps of:

displaying the stock code substantially adjacent to the indicator means so that a visual association is formed there between;

setting stock codes for which a reminder that a sign or other form of notification or advertisement in respect of the associated stock items should be put up or placed has become due to a third colour state;

setting stock codes for which a reminder that a sign or other form of notification or advertisement in respect of the associated stock item should be taken down or discontinued to a fourth colour state.

Preferably, the method further comprises the step of displaying the total number of requests made in respect of a stock item on activation of the indicator means associated with the stock item.

Preferably, the method further comprises the step of displaying contact details of the requestor and the stock code of the stock item to which the request relates.

Preferably, the method further comprises the steps of categorising the stock codes and displaying to a user interface only those indicator means associated with a stock code of a single category.

Preferably, the method further comprises the step of calculating statistical information in respect of requests, stock items and/or requestors.

Preferably, the method further comprises the step of providing a menu to the requestor in the event that either the requestor's contact details or the stock item to which the request relates could not be automatically ascertained.

Preferably, the method further comprises the steps of:

establishing a voice mailbox for a stock item;

recording a message for the voice mailbox; and

playing the message to the requester upon receipt of a request related to the stock item associated with the voice mailbox.

Preferably, the method further comprises the steps of:

searching for stock items having similar characteristics to the stock item to which the requestor's request relates; and

providing details of the suggested stock items to the requestor.

### BRIEF DESCRIPTION OF THE DRAWINGS

The invention will be better understood in the light of the following description of two specific embodiments thereof. The description is made with reference to the following drawings, wherein:

FIG. 1 is a screen capture of a Main Switch screen display;

FIG. 2 is a screen capture of a Database screen display;

FIG. 3 is a screen capture of a Sign Manager screen display;

FIG. 4 is a screen capture of a Stock Item Inventory screen display;

FIG. 5 is a screen capture of a Reminders screen display;

FIG. 6 is a screen capture of a first variation of a Log Manager screen display;

FIG. 7 is a screen capture of a second variation of the Log Manager screen display;

FIG. 8 is a screen capture of a third variation of the Log Manager screen display;

FIG. 9 is a screen capture of a first screen of a Statistics Module;

FIG. 10 is a screen capture of a second screen of the Statistics Module;

FIG. 11 is a screen capture of a third screen of the Statistics Module;

FIG. 12 is a screen capture of a Play/Record screen display;

FIG. 13 is a screen capture of a voice mailbox directory; and

FIG. 14 is a screen capture of a compact window.

### BEST MODE(S) FOR CARRYING OUT THE INVENTION

In accordance with a first embodiment of the invention there is a system for managing requests incorporating a user interface 10. The user interface 10 is implemented in a computer system connected to at least one communication line (not shown). The communication line may, for example, be a phone line or cable internet connection. The computer system is also connected to a keyboard and mouse.

The communication line is used as the conduit for requests, whether by phone, short-messaging service (“SMS”), e-mail or other format. Requests sent via the communication line are received by a communications module (also not shown).

The communications module provides an interface to the customer who has placed the request. The interface provided by the communications module performs the following steps:

1. Automatically determining contact details of the customer seeking to place the request. In the case of phone or SMS requests this can be achieved by using caller ID technology to obtain the customer's phone number, as appropriate. In the case of e-mail requests, this can be done by deconstructing the header of the e-mail message into its distinct fields and identifying the sender's e-mail address from the deconstructed header;

2. Identifying the stock code the subject of the request. This can be achieved by:

recording any additional digits pressed by the customer after a separator key, such as the ‘#’ key, the additional digits representing a stock code; or

capturing the stock code from the text of the SMS message or the body text of the e-mail message. In these cases, it is desirable that the text or body text, as applicable, contain a single stock code or a series of stock codes separated by a separator character;

3. Determining the customer's desired means of receiving information pursuant to their request, ie. facsimile, telephone or e-mail;

4. Associating the customer's request with the appropriate stock item (as determined with reference to the stock code) and recording the request and customer's details in a log file. The log file may be a flat file arrangement or a relational database; and

5. Presenting a standard greeting message to the caller in a format appropriate to the request format (ie. voice message in the case of telephone calls, text message in the case of SMS or e-mail requests). The greeting message is “standard” only in the sense that the same message is provided to all customers. In the case of SMS or e-mail requests, the standard greeting message acts as confirmation to the customer that the request has been received and is being processed.

The user interface 10 comprises a series of screen displays 12 and background communication processes. The user interface 10 described hereafter has been adapted for use in a real estate agency.

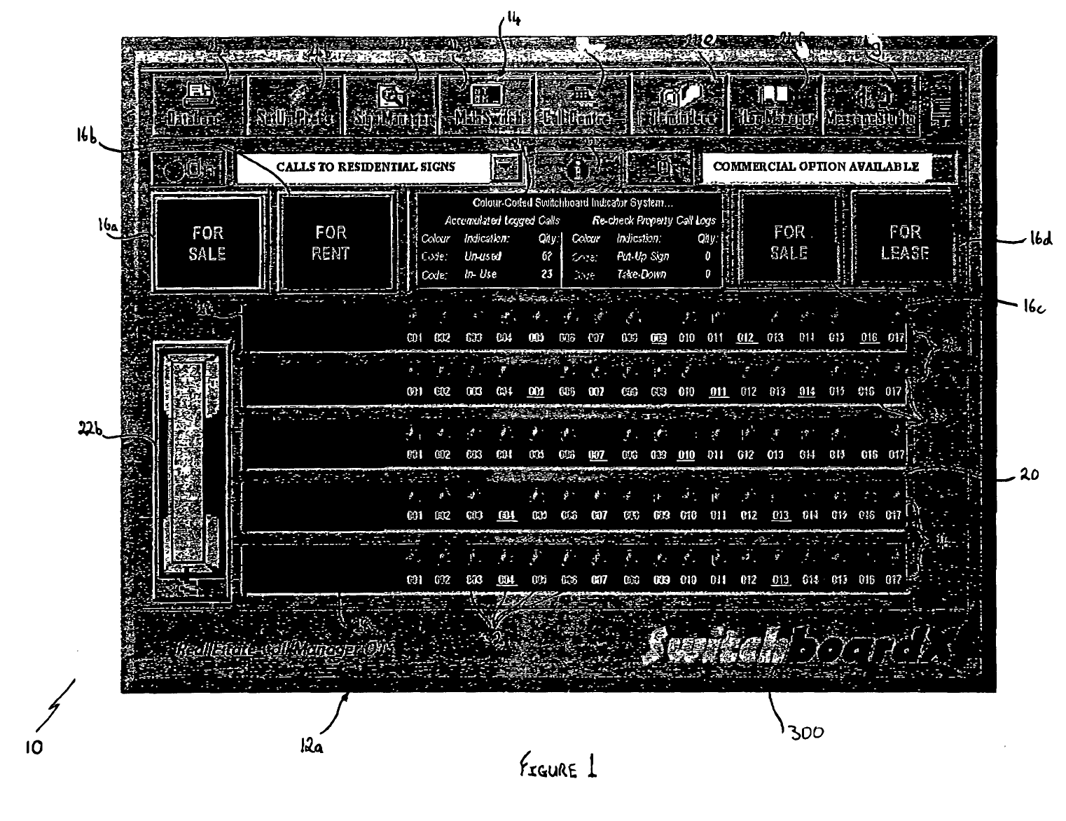

A first screen display 12a is shown at FIG. 1. This first screen display 12a comprises a menu bar 14, counter windows 16, a status box 18 an indicator panel 20 and link icons 22. The first screen display 12a is referred to hereafter as the Main Switch screen display 12a.

The menu bar 14 is located at the top of the Main Switch screen display 12a and extends the full width of the Main Switch screen display 12a. The menu bar 14 is a static item that is common to every screen display 12.

The menu bar 14 comprises a series of icons 24. Each icon 24 provides access to a predetermined screen display 12. For example using the mouse to click on:

icon 24a provides access to the Database screen display 12b.

icon 24b provides access to the SetUp Preference screen display 12c.

icon 24c provides access to the Sign Manager screen display 12d.

icon 24d provides access to the Main Switch screen display 12a.

icon 24e provides access to the Reminders screen display 12e.

icon 24f provides access to the Log Manager screen display 12f.

icon 24g provides access to the Play/Record screen display 12g.

Located underneath the menu 14, and to each side of Main Switch screen display 12a are counter windows 16. Each counter window 16 represents a category of stock items. In the embodiment shown in FIG. 1, counter windows 16 are grouped in two different manners, particularly:

counter windows 16a and 16c relate to “for sale” stock items;

counter windows 16b and 16d relate to “for lease/rent” stock items;

counter windows 16a and 16b relate to residential stock items; and

counter windows 16c and 16d relate to commercial stock items.

Status box 18 is situated between counter windows 16b and 16c, thereby dividing those counter boxes 16a, 16b that relate to residential stock items from those counter boxes 16c, 16d that relate to commercial stock items.

Both counter windows 16 and status box 18 are operably linked with indicator panel 20, thus, their operation will be described in more detail below.

Indicator panel 20 comprises a series of indicator strips 26. The indicator strips 26 extend transverse to the Main Switch screen display 12a and are arranged parallel to each other. Each indicator strip 26 comprises a tag 28 and a plurality of indicator lights 30. The tags 28 identify the current category of stock items displayed by each indicator strip 26 and correspond to one of the counter windows 16. The plurality of indicator lights 30 are linearly arranged along the length of the indicator strip 26.

Each indicator light 30 is associated with a stock code 32. In the embodiment shown in FIG. 1, the stock code 32 is a number. However, in other embodiments the stock code 32 can be alphabetical or alphanumerical. The stock code 32 may be associated with a stock item (not shown).

Indicator lights 30 have three states of illumination—off, periodic or on.

An indicator light 30 is set to the “off” state of illumination to indicate that there have been no requests made in respect of the associated stock item (as determined by corresponding stock codes 32).

An indicator light 30 is set to the “periodic” state of illumination to indicate that there is at least one new request made in respect of the associated stock item (as determined by corresponding stock codes 32) that has not been attended to.

An indicator light 30 is set to the “on” state of illumination to indicate that all requests made in respect of the associated stock item (as determined by corresponding stock codes 32) have been attended to.

In a similar manner, stock codes 32 have four colour states—orange, white, green and magenta.

A stock code 32 is set to the “orange” colour state to indicate that the stock code 32 has not yet been associated with any particular stock item. This is the default colour state of each stock code 32.

A stock code 32 is set to the “white” colour state to indicate that the stock code 32 has an association with a particular stock item.

A stock code 32 is set to the “green” colour state to indicate that a sign or other form of notification or advertisement should be placed adjacent the stock item associated with the stock code 32.

A stock code 32 is set to the “magenta” colour state to indicate that a sign or other form of notification or advertisement should be removed from its placement or discontinued.

The status box 18 displays summary information in respect of the indicator lights 30 and stock codes 32. On the left side of status box 18, the status box 18 displays the number of used stock codes 32 (ie. those having a white colour state) and the number of un-used stock codes 32 (ie. those having an orange colour state). On the right side of status box 18, the status box 18 displays the number of stock codes 32 for which signs or other forms of notification that need to be “put-up” (ie. those having a green colour state) and the number for stock codes 32 for which signs or other forms of notification need to be “taken down” (ie. those having a magenta colour state).

Manoeuvring a mouse pointer over the top of an indicator light 30 or stock code 32 initiates certain actions. When the mouse pointer is manoeuvred over the top of an indicator light 30, the counter window 16 corresponding to tags 28 changes to display the number of requests recorded in respect of the associated stock item (as determined by corresponding stock codes 32). When the mouse pointer is manoeuvred over the top of a stock code 32, a temporary window (not shown) is created displaying a textual description of the associated stock item. Selecting a stock code 32, by clicking the left mouse button thereon, opens Sign Manager screen display 12d if the stock code 32 is set to colour state orange. If the stock code 32 is set to any other colour state, selecting the stock code 32 in this manner opens the first variation of Log Manager screen display 12f.

To change the category of stock items being displayed, the counter window 16 corresponding to the new category of stock items is selected. This selection causes tags 28, indicator lights 30 and stock codes 32 of the indicator panel 20 to change to reflect those codes of the new category of stock items.

The two link icons 22 comprise multi-purpose link icon 22a and statistics link icon 22b. The multi-purpose link icon 22a is a generic link. It can be used to link to other functional aspects of the user interface 10 or to other software applications. Statistics link icon 22b is a link to Statistics module 23.

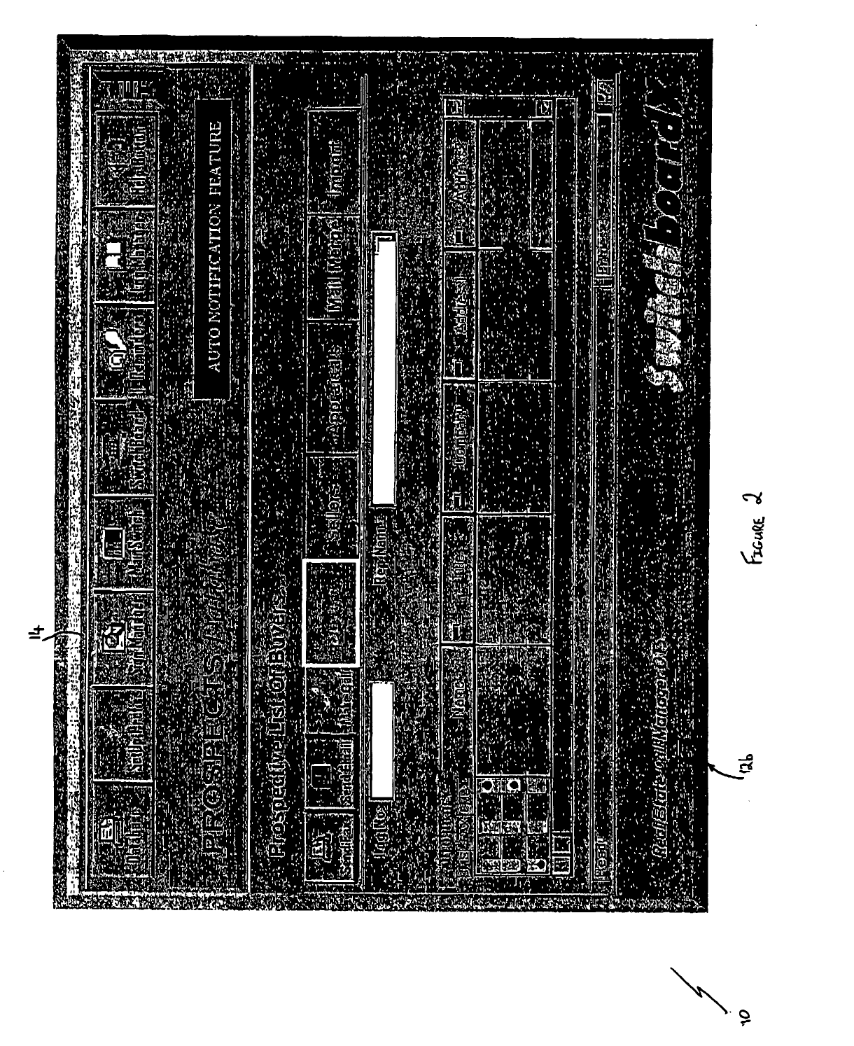

Database screen display 12b is shown at FIG. 2. This screen display 12b displays details of all potential customers to the user. This screen display 12b can also be used to enter/edit details of potential customers, for example, in situations where a potential customer walks-in off the street and requests information in respect of a stock item.

SetUp Preference screen display 12c is not shown in the accompanying figures. This screen display 12c allows the user to configure various aspects of the system and user interface 10. A particular feature of this screen display 12c is that the user can associate files with a stock code 32 for each medium through which a request can be made. The associated file then forms the response to any request made through the designated medium.

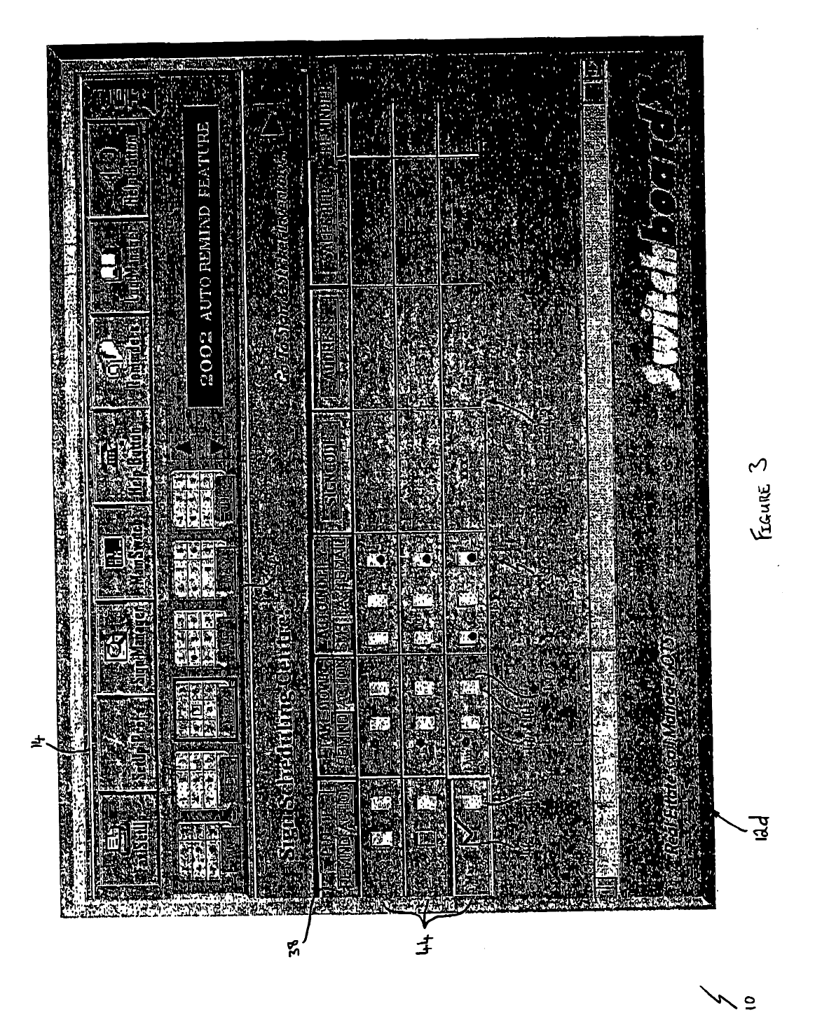

Turning to FIG. 3, the Sign Manager screen display 12d is shown. The Sign Manager screen display 12d comprises menu 14, table 34 and 6-month calendar window 36.

Table 34 comprises Put-Up column 38, Take-Down column 40 and stock item information 42. Each row 44 in the Put-Up Column 38 and Take-Down column 40 comprises two check-boxes 46. Check-box 46a is a reminder check-box while check-box 46b is an action check-box.

When a user wants to set a reminder to indicate that a sign or other form of notification or advertisement should be placed adjacent a stock item, the reminder check-box 46a of Put-Up column 38 associated with the stock item is checked. The date of the reminder is then selected using the 6-month calendar window 36.

In this manner, on the reminder date selected, the stock code 32 associated with the stock item is set to the green colour state. The stock code 32 remains set to the green colour state until action check-box 46b of Put-Up column 38 is checked. When action check-box 46b of Put-Up column 38 is checked, and all mandatory stock item information 42 completed, the associated stock code 32 is set to the white colour state.

If the reminder is not actioned on the set date, ie. at the end of the day the associated action check box 46b of Put-Up column 38 is not set to checked, the stock code 32 to which the reminder applies is set to flash rapidly. The stock code 32 continues to flash rapidly until the associated action check box 46b of Put-Up column 38 is set to checked.

If at the time that reminder check-box 46a of Put-Up column 38 is checked, there is no or incomplete stock item information 42 associated therewith, first variation of Log Manager screen display 12f is activated.

When a user wants to set a reminder to indicate that a sign or other form of notification or advertisement should be removed from its placement or discontinued, the reminder check-box 46a of Take-Down column 40 associated with the stock item is checked. The date of the reminder is then selected using the 6-month calendar window 36.

In this manner, on the reminder date selected, the stock code 32 associated with the stock item is set to the magenta colour state. The stock code 32 remains set to the magenta colour state until action check-box 46b of Take-Down column 40 is checked. When action check-box 46b of Take-Down column 40 is checked, the associated stock code 32 is set to the orange colour state and all associated stock item information 42 is deleted. This typically occurs when the stock item is sold.

Again, if the reminder is not actioned on the set date, ie. at the end of the day the associated action check box 46b of Take-Down column 40 is not set to checked, the stock code 32 to which the reminder applies is set to flash rapidly. The stock code 32 continues to flash rapidly until the associated action check box 46b of Take-Down column 40 is set to checked.

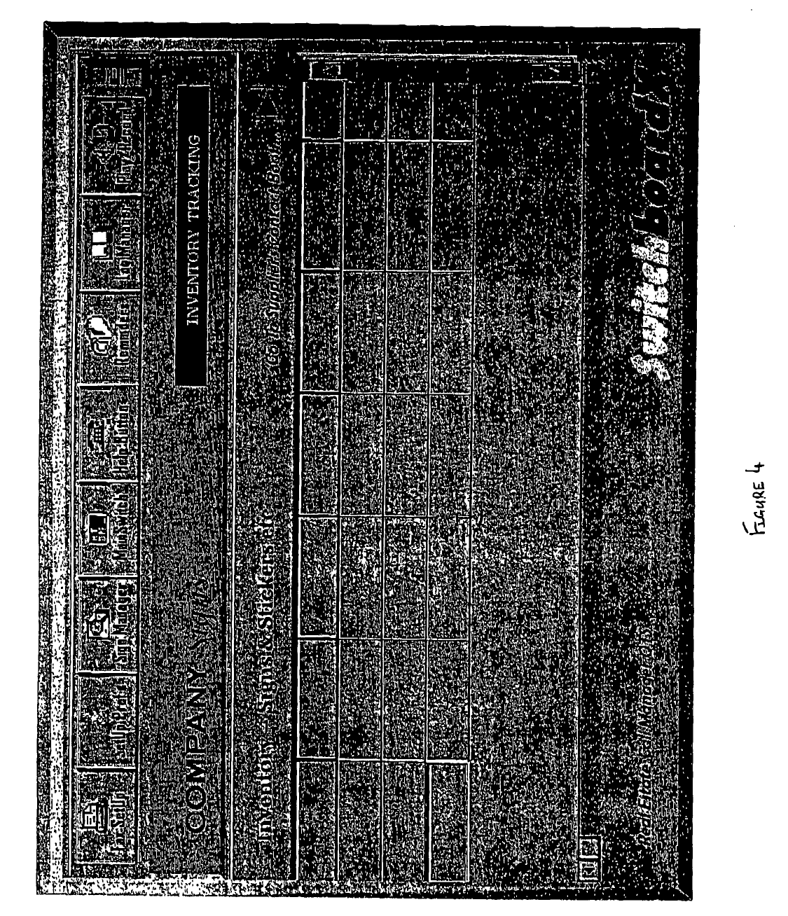

Stock codes 32 may also be highlighted in some manner, such as the use of underlining or italicised text, to indicate to the user that there are no more signs or advertising material available to be put up. In determining whether a sign or advertising material is available, an inventory system is provided (see FIG. 4). The inventory system records details of each type of sign or other advertising material available to the user. As signs or advertising material are put up, the inventory system decrements the number of signs or advertising material of the appropriate type available to the user. As signs or advertising material are taken down, the inventory system increments the number of signs or advertising material of the appropriate type available to the user.

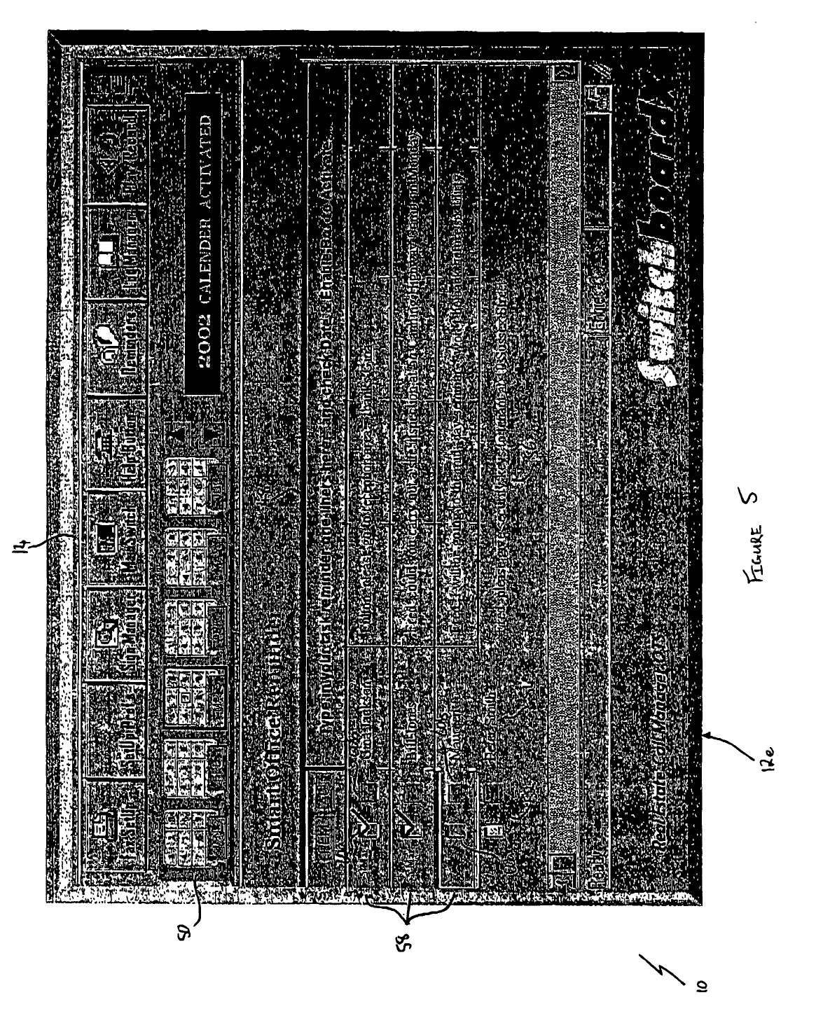

The Reminders screen display 12e is shown at FIG. 5. The Reminders screen display 12e comprises menu 14, table 48 and 6-month calendar window 50.

Table 48 comprises reminder column 52, rep column 54 and reminder text column 56. Each row 58 in the reminder column 52 comprises two check-boxes 60. Check-box 60a is a reminder check-box while check-box 60b is an action check-box.

When a user wants to set a generic reminder:

the reminder check-box 60a of a row 58 is checked;

the name of the person who initiated the generic reminder is recorded in the rep column 54;

the text of the generic reminder is entered into reminder text column 56.

the date of the reminder is selected using the 6-month calendar window 50.

On the date selected, the text of the generic reminder, as recorded in reminder text column 56, is displayed to all users in a window (not shown). It is anticipated that in other embodiments the Main Switch screen display 12a may have a status line located underneath the indicator panel 20 and the text of the generic reminder scrolls horizontally along the status line.

The generic reminder will then periodically repeat until such time as the reminder is actioned. Actioning of a generic reminder is recorded by the system through setting action check-box 60b to checked.

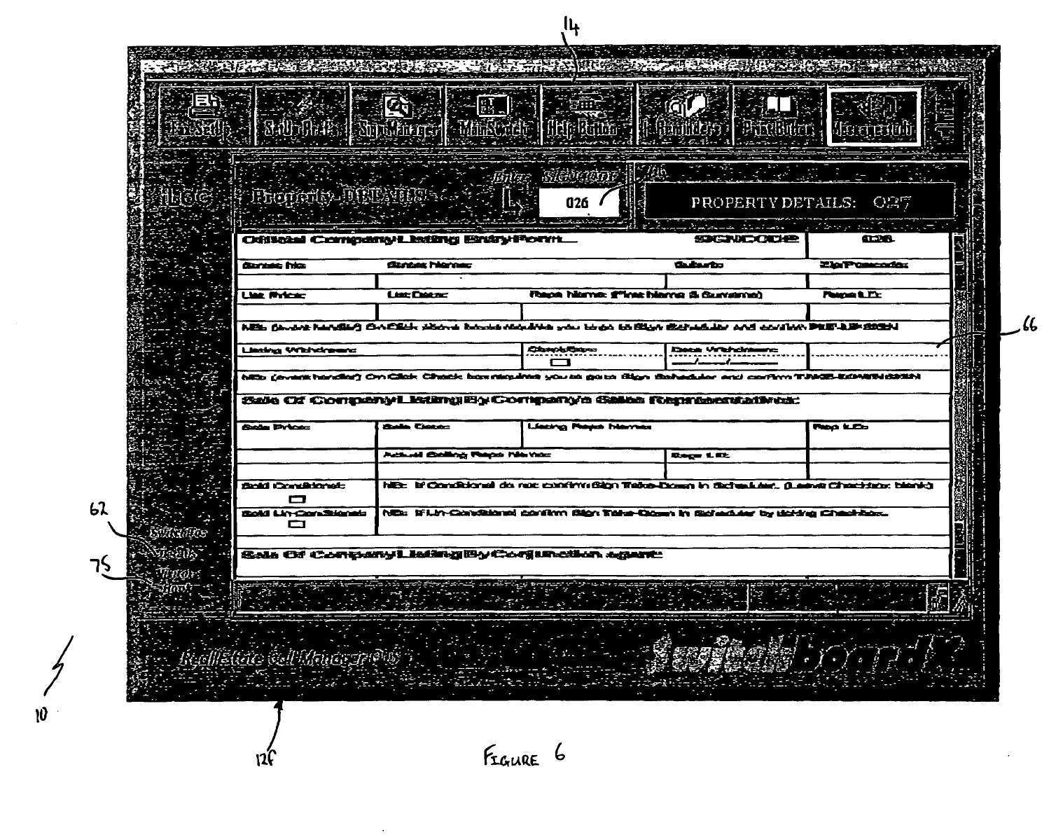

Log Manager screen display 12f is shown at FIGS. 6 to 8. There are three variations of the Log Manager screen display 12f. Switching between the first and second variations can be achieved by clicking on switch button 62.

In the first variation of Log Manager screen display 12f, shown at FIG. 6, the Log Manager screen display 12f comprises switch button 62, stock code field 64 and stock item form 66.

The stock code 32 entered into stock code field 64 determines the stock item information to be displayed in stock item form 66 (ie. information in respect of the stock item associated with the stock code 32). The user is then free to add, delete or otherwise edit the information recorded in stock item form 66 as necessary. The information required by stock item form 66 is dependent on the type of stock item.

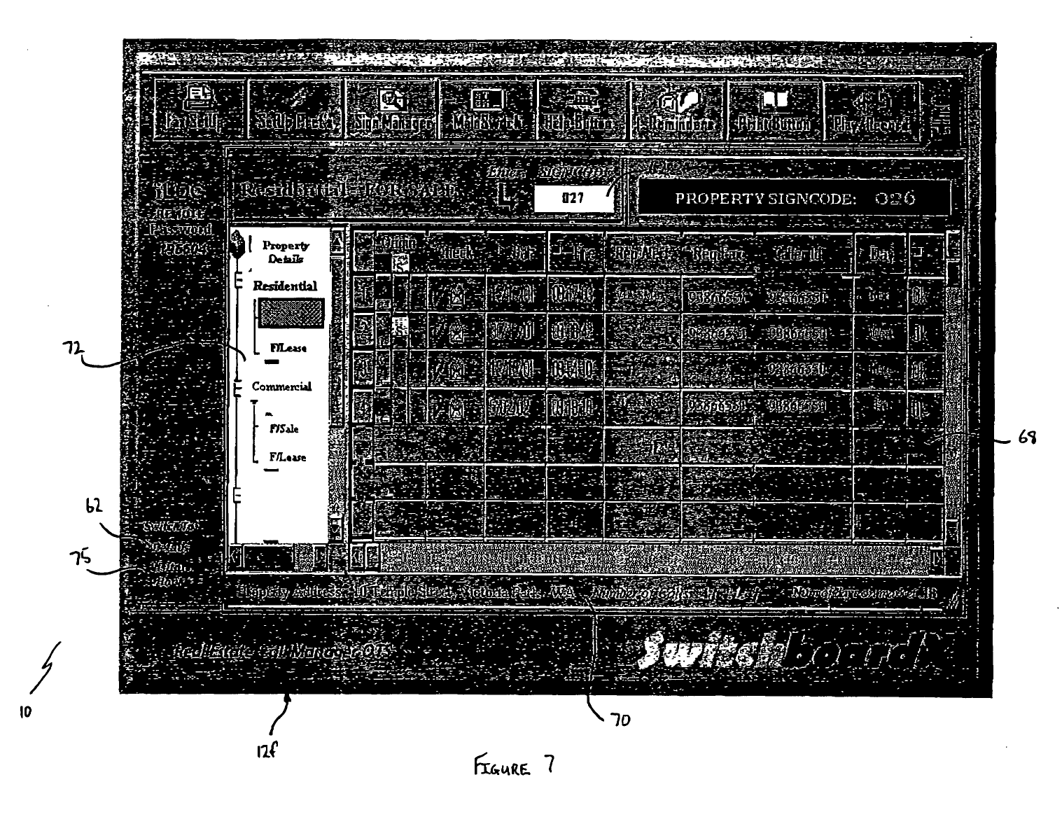

In the second variation of Log Manager screen display 12f, shown at FIG. 7, the Log Manager screen display 12f comprises switch button 62, stock code field 64, request window 68 and footer 70.

Request window 68 comprises a tree structure 72 and a request table 74. Tree structure 72 lists, in a tree-like format, the categories of stock items the subject of counter windows 16. The user can select a category of stock items from the tree-like format. The combination of stock code 32 entered into stock code field 64 and the selected category of stock items determines the information to be displayed in request table 74.

Request table 74 presents to the user information on all requests recorded in the log files (not shown) relating to the stock code 32. This information can be varied, but at a minimum should include:

contact details of the customer who placed the request in the form of one or more of the following: facsimile number, e-mail address or telephone number; and

date and time the request was made;

details as to whether the request has been attended to or not.

In the embodiment shown at FIG. 7, details as to whether a request has been attended to is illustrated by a tick and open envelope item.

The combination of stock code 32 entered into stock code field 64 and the selected category of stock items also determines the information to be displayed in footer 70. In the embodiment shown, the information displayed in footer 70 are a general description of the stock item, the total number of requests received in respect of the stock item and the number of days the stock item has been available for sale.

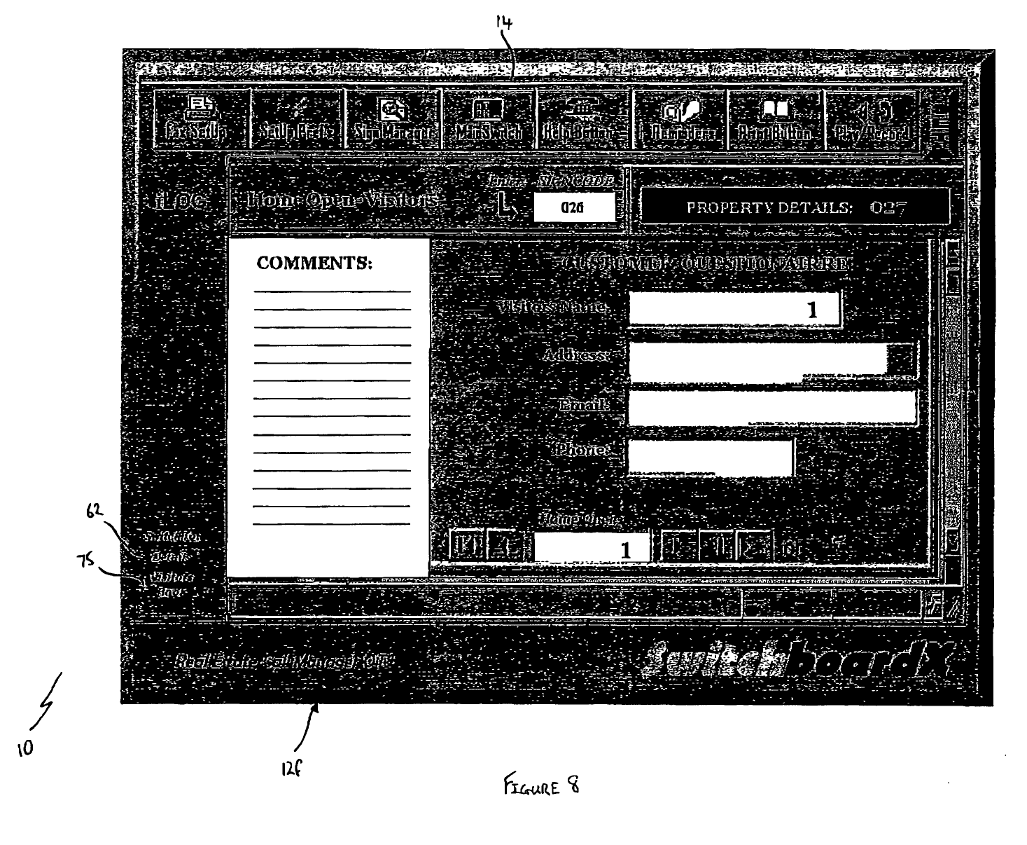

In the third variation of Log Manager screen display 12f, shown at FIG. 8, details of people who have inspected a stock item can be entered as well as their comments on the stock item. Each person's details and comments are associated with a stock code 32 as entered in stock code field 64. This third variation of Log Manager screen display 12f is accessed through the visitors book button 75.

In this embodiment, the Play/Record screen display 12g is not necessary and therefore will not be described here.

Statistics module 23 comprises a series of screen displays 76. The statistics compiled and presented by statistics module 23 can vary according to the needs of the user. For example:

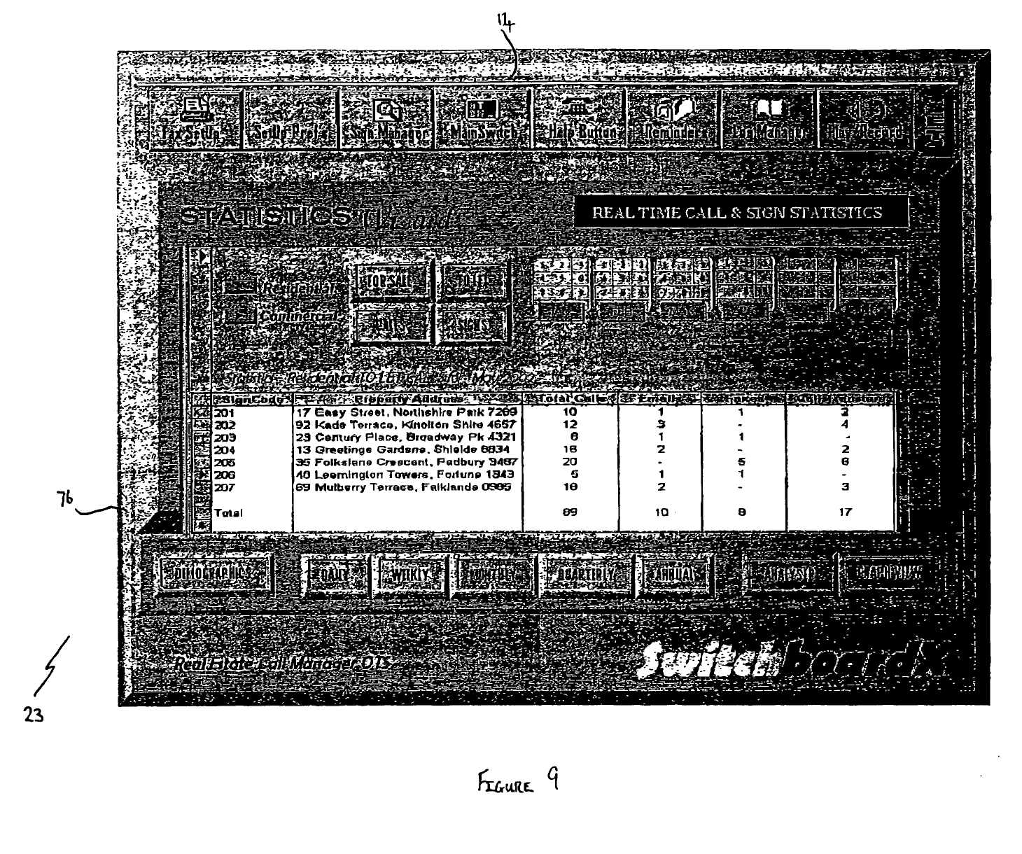

at FIG. 9, screen display 76 presents to the user statistics in respect of requests made to the category of items that are available for sale and designated residential within the period Apr. 1, 2002 to Jun. 30, 2002.

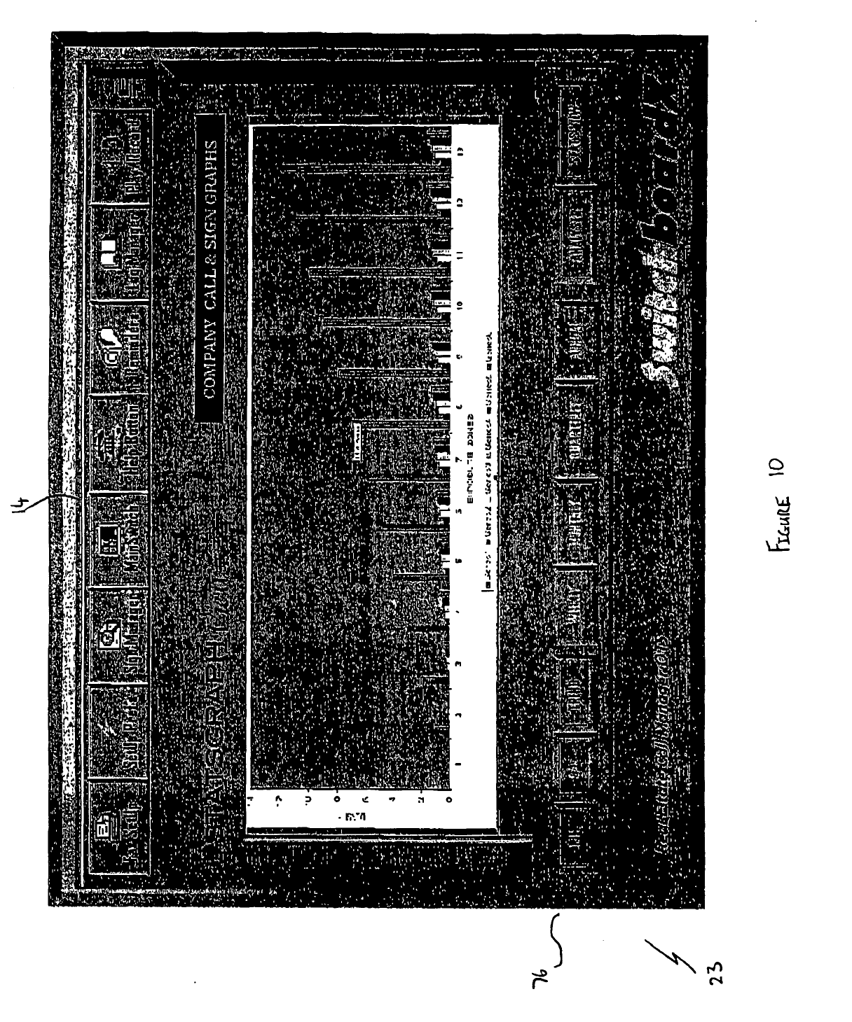

at FIG. 10, screen display 76 presents to the user a statistical graph of requests recorded in the log files.

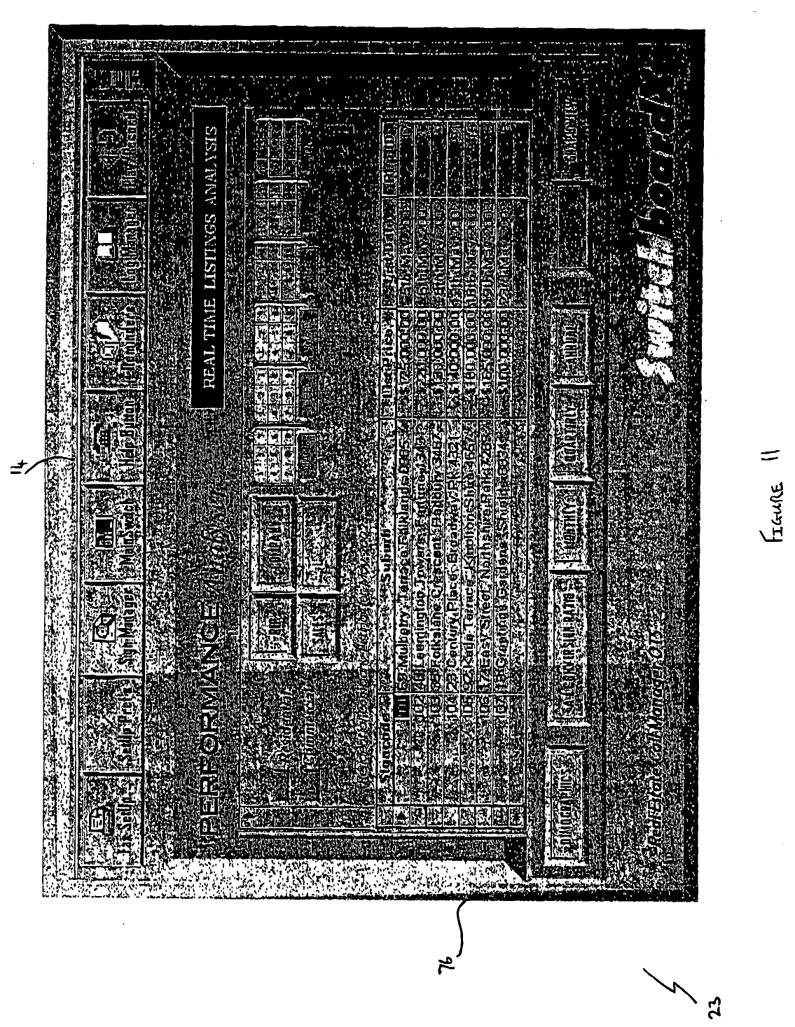

At FIG. 11, screen display 76 presents to the user statistics in respect of sales performance over a set time period, the statistics being able to be grouped by company or representative and by nature of the stock item (ie. residential or commercial).

Other statistics, such as totals of the number of requests by request medium, etc. could also be implemented. Importantly, however, is the fact that the statistics module 23 provides statistical analysis on a real-time basis.

In a second embodiment of the invention, where like numerals reference like parts, the user interface 10 for managing requests is adapted for primary use in handling telephone requests.

In this embodiment, in addition to the steps mentioned above, the communications module performs the following steps:

1. In the event that the customer has not entered a stock code through use of a separator key or the customer has blocked their caller ID, providing to the user a voice menu. The voice menu may provide a multitude of options to the customer, but at the minimum should include procedures by which the communications module captures contact details for the customer and provide the customer with an option to enter in a stock code;

2. Playing to the customer a pre-recorded voice mail message associated with an entered stock code;

3. While the pre-recorded voice mail message associated with an entered stock code is playing, searching for stock items having similar characteristics as the stock item associated with the entered stock code and, upon completion of the pre-recorded voice mail message, suggesting to the customer that they also listen to the pre-recorded voice mail message in respect of these other stock items and providing the appropriate stock codes to allow them to do so. The parameters used to perform this search may be set by either the user or the customer and may be based on characteristics such as price, location, type, etc.; and

4. Upon completion of the pre-recorded voice mail message, querying with the customer whether they wish to be contacted by the designated sales representative for the stock item associated with the entered stock code.

In this manner, if the customer does not request further contact by the designated sales representative, the customer's request has been automatically attended to by the communications module.

The association between stock codes and pre-recorded voice mail messages in this embodiment necessitates that the user interface provide means for creating a voice mail message 100 and associating it with a stock code 32. Primarily, this is provided for by automatically activating Play/Record screen display 12g upon completion of all mandatory stock item information 42. Note, that in this embodiment, until a voice mail message 100 has been recorded, the associated stock code 32 is not set to the white colour state.

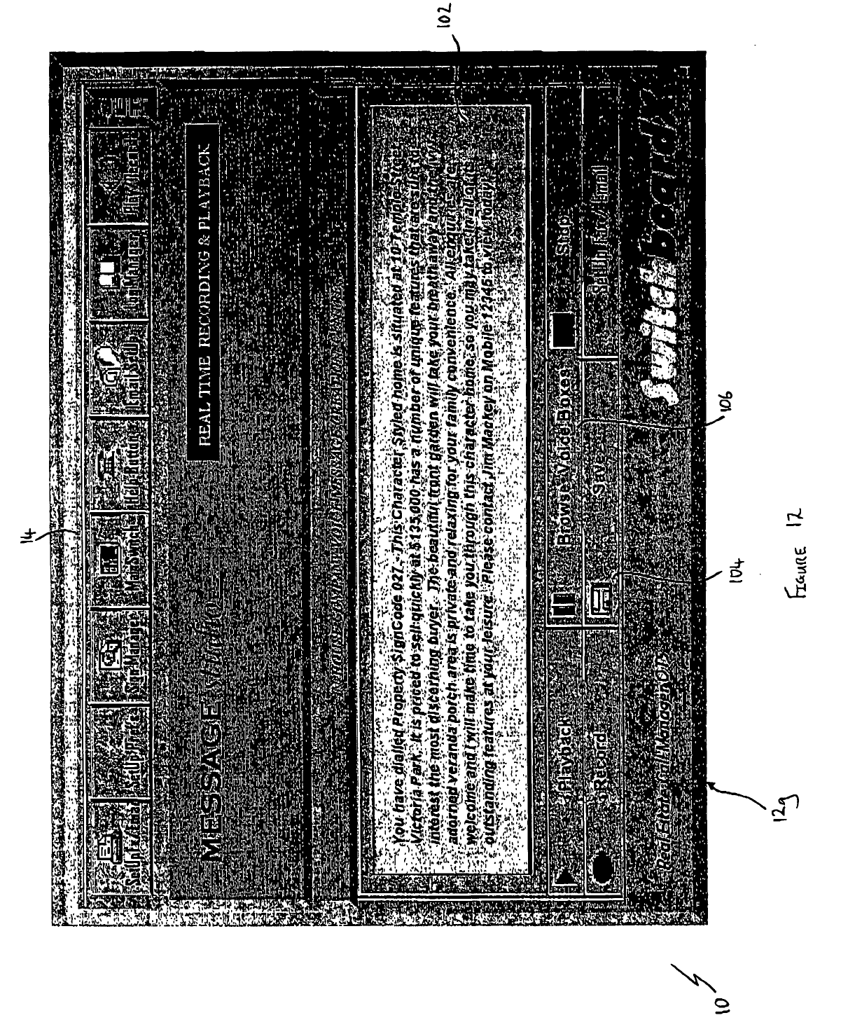

Play/Record screen 12g comprises a text box 102, control buttons 104 and voice box button 106 (see FIG. 12). Using the Play/Record screen 12g, the user has two options for recording a voice mail message 100.

In the first option, the user enters the text of the voice mail message 100 into text box 102. Once the full text of the voice mail message 100 has been entered into text box 102, the text can be digitised using text-to-speech technology as would be known to the person skilled in the art. The resulting digitised speech is then stored as the voice mail message 100 associated with the stock code 32. The text entered into text box 102 is stored as an associated field to the voice mail message 100, such that small changes to the voice mail message 100 may be effected without the need to re-enter the text.

In the second option, using control buttons 104, the user can record the voice mail message 100 themselves. In doing so, the user has the option of entering the text of the voice mail message 100 into text box 102, the text of the voice mail message 100 thereafter acting as an autocue for the user. When the user is satisfied with the voice mail message 100 the “Save” control button 104 is selected and the voice mail message 100 is associated with stock code 32.

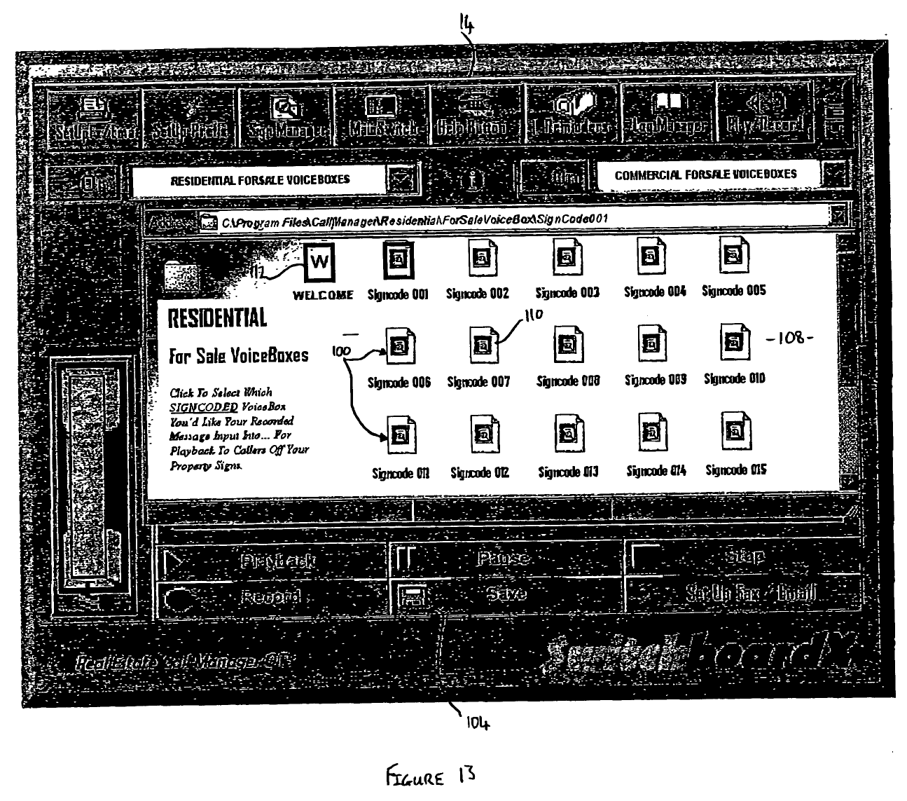

If the voice box button 106 is selected by the user, the voice box button 106 and text box 102 disappears. The space previously taken up by text box 102 is replaced with a directory window 108, similar to those provided by the Windows Explorer™ product by Microsoft Corporation. Each voice mail message 100 is represented as an icon 110 in the directory window 108. The standard greeting message played to all callers is also represented as an icon 112 in the directory window 108. This is shown graphically at FIG. 13.

The user can select any icon 110, 112 as a means of re-recording the voice mail message 100. When an icon 110, 112 is selected, voice box button 106 and text box 102 are restored and the user is able to re-record the voice mail message 100 associated with the selected icon 110, 112 in the same manner as described above.

Further, in this embodiment, if the customer has indicated that they wish to be contacted by the designated sales representative for the stock item associated with the entered stock code, the designated sales representative is sent a message to do so. The message necessarily includes the contact details of the customer.

The message may be of any format, but given the proliferation of SMS-enabled mobile phones among real estate professionals, the message is more likely to be an SMS message.

In a third embodiment of the invention, where like numerals reference like parts, the user interface 10 is expanded upon and is particularly adapted for in-house use.

In this embodiment, the computer is further connected to an electronic billboard (not shown). The electronic billboard is sited at the user's premises and is preferably arranged either to display information to people as they enter the user's premises or arranged to display information to people as they exit the user's premises.

The electronic billboard is used as a generic display means. The electronic billboard may display real-time statistical information generated by statistics module 23. Alternatively, the electronic billboard may display a series of pictures of stock items, each with their associated stock code 32. In a yet further alternative, the electronic billboard may be used to display special messages, such as messages of congratulations to the purchasers of stock items.

It is further anticipated that the billboard may take the form of an electronic directory. In this manner, the billboard would present to a customer a graphical depiction of stock items in a “thumbnail” format. The customer could then select the stock item they wish to view in more detail in a known manner, for example by pointing to the thumbnail in the case of a touch-screen billboard, this being treated as a request. The system would then display on the billboard a larger picture of the stock item and certain specified characteristics of that stock item. The anticipated method of display of these specified characteristics is via a scrolling text bar.

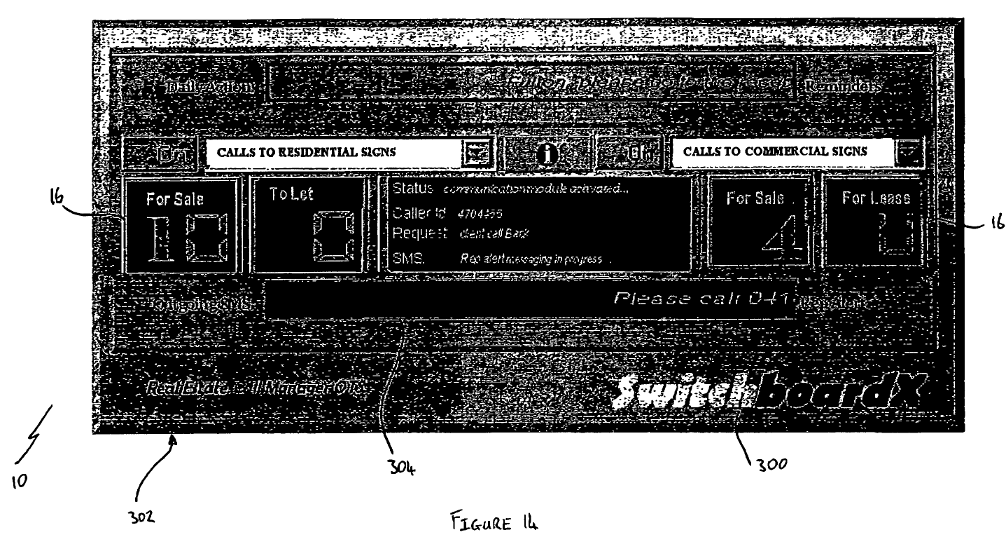

In a fourth embodiment of the invention, where like numerals reference like parts, Main Switch screen display 12a includes text 300. When clicked upon, text 300 closes Main Switch screen display 12a and initiates compact window 302 (see FIG. 14).

Compact window 302 comprises a reminder scroll-bar 304, counter windows 16 and text 300. The text of generic reminders scrolls horizontally along the length of reminder scroll-bar 304. Counter windows 16 are also modified so as to display the total number of requests received in that category of stock items.

When in compact window 302 mode, clicking on text 300 closes compact window 302 and replaces it with Main Switch screen display 12a.

It should be appreciated by the person skilled in the art that the above embodiments are provided as examples only. Modifications and variations of the above embodiments are considered to fall within the scope of the invention, as do embodiments encompassing combinations of features disclosed in the above embodiments.

In particular, the following modification or variations may be embodied in further embodiments:

Stock codes 32 can be segmented. In this manner, a segment of the stock code 32 can be allocated to identifying the medium by which the customer's attention was drawn to the associated stock item, ie. magazine, radio or television advertisement, etc. Additional segments can be used to identify the category of stock item that the stock code 32 relates to.

The system may be adapted to be used by sales representatives. In this situation, the request may be for information as to the location of the stock item associated with the inputted stock code 32. The request can then be satisfied by responding with a textual or graphical depiction of the location of the stock item. If implemented, the response to the request may include a textual or graphical depiction of the location of stock items that have similar characteristics to the stock item associated with the inputted stock code 32.

The user interface 10 may be modified to allow remote access by sales representatives or other parties to particular screen displays 12, such as the Main Switch screen display 12a, Sign Manager screen display 12d and the Log Manager screen display 12f.

The communication module may be adapted to handle facsimile requests by implementing optical character recognition technology or other methods to identify the stock code to which the request relates.

6-month calendar windows 36, 50 may be omitted to be replaced by a pop-up calendar window activated upon setting a reminder check-box to checked.

Other methods of distinguishing between states can be used in respect of the indicator lights and stock codes. For example, borders or fonts may be used to distinguish between states.

The user interface may be adapted for use within other good or service areas, for example, such as car-yards and stockbrokers.

### Amendment to the Specification

On page 1, line 3, please delete the heading “Field of the Invention” and insert the heading “Technical Field” therefor.

On page 1, line 11, please delete the heading “Background Art” and insert the heading “Background” therefor.

On page 2, line 15, please delete the heading “Disclosure of the Invention” and insert the heading “Summary” therefor.

On page 9, line 17, please delete the heading “Best Mode(s) for Carrying Out The Invention” and insert the heading “Detailed Description” therefor.

On page 24, line 1, please delete the heading “The Claims Defining the Invention are as Follows” and insert the heading “Claims” on line 1, and phrase “What is claimed is:” on line 2.

The claims defining the invention are as follows

1. A system for managing requests comprising:
at least one communications line adapted to be used by a requester to place a request with the system;
request means for identifying contact details of the requestor and a stock item to which the request relates; and
a user interface having at least one indicator means thereon, one of the indicator means associated with the stock item to which the request relates,
where when a requestor places a request with the system, the indicator means associated with the stock item to which the request relates is set to a first state indicating that at least one request associated with the stock item has not been attended to, and when all requests associated with the stock item have been attended to, the indicator means associated with the stock item to which the request relates is set to a second state.

2. A system for managing requests according to claim 1, where each stock item is assigned a stock code and each indicator means is associated with a stock code such that the association between indicator means and stock item is through the stock code.

3. A system for managing requests according to claim 1, where the request is placed in one of the following manners: telephone call; facsimile message; e-mail; short messaging system message.

4. A system for managing requests according to claim 1, where the request means identifies the contact details of the requestor by automatic caller identification.

5. A system for managing requests according to claim 2, where the request means identifies the stock item to which the request relates by identifying the stock code contained within the request.

6. A system for managing requests according to claim 1, where the request means also records details from the requestor as to the requestor's desired means of receiving information.

7. A system for managing requests according to claim 1, where the indicator means is a graphical illustration of a light.

8. A system for managing requests according to claim 1, where, when the indicator means is in a first state, the indicator means is periodically illuminated and, when the indicator means is in a second state, the indicator means is permanently illuminated.

9. A system for managing requests according to claim 2, where each indicator means displayed on the user interface has its associated stock code displayed substantially adjacent thereto.

10. A system for managing requests according to claim 2, where each stock code has a state to indicate the status or actions that need to be performed in respect of the stock code.

11. A system for managing requests according to claim 10, where a stock code is set to a first state to indicate that the stock code has not yet been associated with a stock item and is set to a second state to indicate that the stock code has been associated with a stock item;

12. A system for managing requests according to claim 10, where a stock code is set to a third state to indicate that a sign or other form of notification or advertisement in respect of the associated stock item should be put up or placed and is set to a fourth state to indicate that a sign or other form of notification or advertisement in respect of the associated stock item should be taken down or discontinued.

13. A system for managing requests according to claim 10, where the user interface further includes a status box, the status box displaying the total number of stock codes set to each state.

14. A system for managing requests according to claim 1 where the user interface includes a counter window, the counter window displaying the total number of requests made in respect of a stock item on activation of the indicator means associated with the stock item.

15. A system for managing requests according to claim 2, further comprising reminder means adapted to provide reminders to indicate that a sign or other form of notification or advertisement should be put up or placed and adapted to provide reminders to indicate that a sign or other form of notification or advertisement should be taken down or discontinued, each such reminder associated with a stock code.

16. A system for managing requests according to claims 12 and claim 15, where actioning a reminder indicating that a sign or other form of notification or advertisement should be put up or placed changes the stock code to the third state and satisfying a reminder indicating that a sign or other form of notification or advertisement should be taken down or discontinued changes the stock code to the second state.

17. A system for managing requests according to claim 16, where if the reminder is not actioned within a predetermined time period, the stock code associated with the reminder flashes periodically.

18. A system for managing requests according to claim 16 where, upon activation, the reminder is displayed in a scrolling text bar.

19. A system for managing requests according to claim 2, where the user interface further comprises means for displaying contact details of the requestor and the stock code of the stock item to which the request relates.

20. A system for managing requests according to claim 1, further comprising statistics means for generating statistical information in respect of requests, stock items and/or requesters.

21. A system for managing requests according to claim 1, where, when the request means cannot identify the contact details of the requestor or the stock item to which the request relates, the request means presents to the requester a menu, the menu allowing the requestor to enter in their contact details and/or designate the stock item to which the request relates.

22. A system for managing requests according to claim 1, further comprising at least one voice mailbox, each voice mailbox associated with a stock item, such that, when the means of placing the request is a telephone call, the requestor hears the message recorded in the voice mailbox associated with the stock item their request relates to.

23. A system for managing requests according to claim 22, further comprising means for recording a message and storing it in a voice mailbox.

24. A system for managing requests according to claim 1, whereby the system further comprises suggestion means, the suggestion means adapted to search for stock items having similar characteristics to the stock item to which the requestor's request relates and providing details of the suggested stock items to the requestor.

25. A system for managing requests according to claim 1, further comprising an interactive screen display, the user interface being adapted to accept a request from a requestor using the interactive screen display.

26. A user interface for a system for managing a request from at least one communication line, the request identifying a stock item to which the request relates, the user interface comprising at least one indicator means, one of the at least one indicator means associated with the stock item the request relates to, where, when a requestor places the request, the indicator means associated with the stock item is set to a first state indicating that at least one request associated with the stock item has not been attended to, and when all requests associated with the stock item have been attended to, the indicator means associated with the stock item to which the request relates is set to a second state.

27. A user interface as claimed in claim 26, where each stock item is assigned a stock code and the stock code is displayed on the user interface at a position substantially adjacent to the indicator means associated with the stock item, such that a visual association is formed between the indicator means and the stock code.

28. A user interface as claimed in claim 26 where the indicator means is a graphical illustration of a light.

29. A user interface as claimed in claim 26, where, when the indicator means is in a first state, the indicator means is periodically illuminated and, when the indicator means is in a second state, the indicator means is permanently illuminated.

30. A user interface as claimed in claim 27, where each stock code has a state to indicate the status or actions that need to be performed in respect of the stock code.

31. A user interface as claimed in claim 27, where a stock code is set to a first state to indicate that the stock code has not yet been associated with a stock item and is set to a second state to indicate that the stock code has been associated with a stock item.

32. A user interface as claimed in claim 27, where a stock code is set to a third state to indicate that a sign or other form of notification or advertisement in respect of the associated stock item should be put up or placed and is set to a fourth state to indicate that a sign or other form of notification or advertisement in respect of the associated stock item should be taken down or discontinued.

33. A user interface as claimed in claim 27, the user interface further comprising a status box, the status box displaying the total number of stock codes set to each state.

34. A user interface as claimed in claim 26, the user interface further comprising a counter window, the counter window displaying the total number of requests made in respect of a stock item on activation of the indicator means associated with the stock item.

35. A method of managing requests comprising:
receiving a request via a communications line;
identifying the contact details of the requestor and a stock item to which the request relates;
setting an indicator means associated with the stock item to a first state indicating that at least one request associated with the stock item has not been attended to; and
setting an indicator means associated with the stock item to a second state indicating when all requests associated with the stock item have been attended to.

36. A method according to claim 35, further comprising the steps of associating each stock item with a stock code and associating each indicator means with a stock code.

37. A method according to claim 35, further comprising the step of obtaining details of the requestor's desired means of receiving information and responding to the request using the requestor's desired means of receiving information.

38. A method according to claim 36, further comprising the steps of:
displaying the stock code substantially adjacent to the indicator means so that a visual association is formed there between;
setting stock codes not associated with a stock item to a first state;
setting stock codes associated with a stock item to a second state;

39. A method according to claim 36, further comprising the steps of:
displaying the stock code substantially adjacent to the indicator means so that a visual associated is formed there between;
setting stock codes for which a reminder that a sign or other form of notification or advertisement in respect of the associated stock items should be put up or placed has become due to a third state;
setting stock codes for which a reminder that a sign or other form of notification or advertisement in respect of the associated stock item should be taken down or discontinued to a fourth state.

40. A method according to claim 35, further comprising the step of displaying the total number of requests made in respect of a stock item on activation of the indicator means associated with the stock item.

41. A method according to claim 36, further comprising the step of displaying contact details of the requestor and the stock code of the stock item to which the request relates.

42. A method according to claim 35, further comprising the step of calculating statistical information in respect of requests, stock items and/or requesters.

43. A method according to claim 35, further comprising the step of providing a menu to the requestor in the event that either the requestor's contact details or the stock item to which the request relates could not be automatically ascertained.

44. A method according to claim 35, further comprising the steps of:
establishing a voice mailbox for a stock item;
recording a message for the voice mailbox; and
playing the message to the requestor upon receipt of a request related to the stock item associated with the voice mailbox.

45. A method according to claim 35, further comprising the steps of:
searching for stock items having similar characteristics to the stock item to which the requestor's request relates; and
providing details of the suggested stock items to the requestor.
